(19) United States
(12) Patent Application Publication
(10) Pub. No.: US 2020/0304000 A1
(43) Pub. Date: Sep. 24, 2020

(54) GENERATOR WITH REDUCED MAGNETIC RESISTANCE

(71) Applicant: Kaisei Co., Ltd, Tokyo (JP)

(72) Inventors: Akihiko Tanaka, Saitama (JP); Takashi Kamezawa, Saitama (JP)

(21) Appl. No.: 15/775,823

(22) PCT Filed: Aug. 21, 2017
(86) PCT No.: PCT/JP2017/029823

§ 371 Date: May 11, 2018

(30) Foreign Application Priority Data
Dec. 28, 2016 (JP) 2016-256100

(51) Int. Cl. H02K 16/04

(52) U.S. Cl. CPC H02K 16/04

(57) ABSTRACT

A generator with reduced magnetic resistance may include a cylindrical rotor attached to a rotation axis and rotatably supported by a housing. The generator may also include a cylindrical inner stator disposed concentrically within the rotor and fixed to the housing. The generator may further include cylindrical outer stator concentrically disposed outside the rotor. Additionally, the generator may include a plurality of permanent magnets cylindrically disposed within the rotor. Further, the generator may include a plurality of coils arranged on the inner stator and on the outer configured to generate an AC voltage when each of the plurality of coils rotates the rotor. At least one of the plurality of coils may be a high inductance coil. When a coil polarity is at power generation, magnetic resistance may be reducable via delaying a phase of interlinkage magnetic flux and an induced current by 180 degrees.

### CROSS-REFERENCE TO RELATED APPLICATIONS

This application claims priority to International Patent Application No. PCT/JP2017/029823, filed on Aug. 21, 2017, and Japanese Patent Application No. JP 2016-256100, filed on Dec. 28, 2016, the contents of both of which are hereby incorporated by reference in their entirety.

### TECHNICAL FIELD

The present invention relates to a generator including a cylindrical rotor and cylindrical stators. The cylindrical rotor has a permanent magnet. In the cylindrical stator, a plurality of coils disposed coaxially with the rotor. The generator generates an AC voltage when the rotor is rotated and reduces magnetic resistance generated so as to block rotation of the rotor.

### BACKGROUND

Conventionally, a generator is known in which an electromotive force (voltage) is generated in a coil when the coil is moved within magnetic field lines. The generator generates electricity by converting the energy of the magnet into electric energy by using electromagnetic induction that current flows in the coil.

In the conventional generators, when the cylindrical rotor having a permanent magnet rotates and passes by the side of a stator coil disposed outside the rotor, depending on the current generated in the stator coil, magnetic field lines are generated around the coil. When the magnetic field lines generate repulsive force in a form that the magnetic field lines collide with magnetic field lines generated from the permanent magnet of the rotor or generate attractive force in the form overlapping in the same direction, the magnetic field lines act to stop the movement of the rotor (this is magnetic resistance). Since the power generation efficiency decreases, extra external energy is required to obtain a constant output power for the magnetic resistance. Consequently, the energy efficiency of the generator decreases.

In view of this, conventionally, the development of a generator having sufficient power generation efficiency with zero magnetic resistance or by reducing the magnetic resistance is proceeding. For example, Japanese Patent No. 4524110 (Patent Literature 1) discloses a generator that cancels out the attractive force of a magnet by shifting the position of each magnet by a uniform angle from an axis in a plurality of generators. Further, Japanese Patent No. 3047180 (Patent Literature 2) and Japanese Patent Application Laid-Open No. 2008-187872 (Patent Literature 3) disclose generators using coreless coils. Furthermore, Japanese Patent Application Laid-Open No. 2015-339270 (Patent Literature 4) discloses a generator in which the core of the coil is shorter than the coil in the axial direction.

### CITATION LIST

### Patent Literature

Patent Literature 1: Japanese Patent No. 4524110
Patent Literature 2: Japanese Patent No. 3047180
Patent Literature 3: Japanese Unexamined Patent Application No. 2008-187872
Patent Literature 4: Japanese Unexamined Patent Application Laid-Open No. 2015-339270

However, in the generator described in Patent Literature 1, it is necessary to dispose a large number of generators, for example, at least four or eight generators, in parallel in the axial direction. To dispose such generators, a wide space is needed in the axial direction, and also economic burden is large. Further, in the power generators described in Patent Literatures 2 and 3, the magnetic resistance can be made zero. On the other hand, since a large amount of electricity generated leaks, the magnetic flux that effectively crosses the coil decreases, and the power generation efficiency decreases. As a result, functions as a generator is not sufficiently exerted. Furthermore, in the invention described in Patent Literature 4, it is necessary to determine the length of the core of a coil to generate electric power with sufficient power generation efficiency by reducing the magnetic resistance. In addition, a rotor in which a permanent magnet is disposed outside a cylindrical stator having the coil, and there is a problem that the power generation efficiency is insufficient.

### SUMMARY

An object of the present invention is to provide a generator with reduced magnetic resistance and excellent power generation efficiency.

According to the present invention for solving the above-described problem, a generator includes a cylindrical rotor, a cylindrical inner stator, and a cylindrical outer stator. The cylindrical rotor is attached to a rotation axis rotatably supported by a housing. The cylindrical inner stator is disposed concentrically with the rotor inside the rotor fixed to the housing. The cylindrical outer stator is disposed concentrically with the rotor outside the rotor. In the rotor, a plurality of permanent magnets is cylindrically disposed in a state in which magnetic poles are alternately different in the rotating direction of the rotor. A plurality of coils for generating an AC voltage when each of the coils rotates the rotor is parallely disposed at positions facing the permanent magnets disposed on the rotor on the side where the inner stator and the outer stator face the rotor, and at least one of the coils disposed on the inner stator and the outer stator is a high inductance coil.

The induction coil is a passive element (coil) that can store energy in a magnetic field formed by flowing current. The amount of stored magnetic energy is determined by its inductance. In accordance with Ampere's Law, by winding the wire many times, the magnetic field inside the coil becomes strong. In accordance with Faraday's law of electromagnetic induction, an induced electromotive force is generated in proportion to a change in the magnetic field in the coil. In accordance with Lenz's law, the induced current flows in a direction hindering a change of the magnetic field. Further, the inductor has the ability to delay and reform an alternating current.

Further, when the interlinkage magnetic flux changes with time, an electromotive force is generated in a coil (electromagnetic induction phenomenon), the electromotive force generated at this time is referred to as an “induced electromotive force”, and the current flowing in a circuit by induced electromotive force is referred to as an “induced current #. The induced electromotive force is proportional to a temporal change of the number of interlinkage magnetic flux (number of turns xinterlinkage magnetic flux) (Faraday's law), and the induced electromotive force is generated in a direction for preventing the change of the interlinkage magnetic flux (Lenz's law, etc.).

According to the present invention, by using a high inductance coil as the coil disposed on the inner stator and the outer stator, with coil polarity at power generation, the phase of the interlinkage magnetic flux and the induced current of a generator is delayed by 180 degrees. Consequently, the magnetic resistance can be zero or reduced.

Further, in the present invention, unlike one stator for one conventional rotor or one stator for a plurality of rotors, by providing an inner stator and an outer stator having coils that generate the induced current on both sides of one rotor, an electromotive force at least twice as high as the conventional electromotive force can be generated, and the decrease in the electromotive force due to reducing the magnetic resistance can be sufficiently suppressed.

Further, in the present invention, when a yoke formed of a magnetic material forming the inner stator and the outer stator has a substantially T-shape in which a top surface is curved along the inner or outer surface of the facing rotor, and an axis line of the yoke is disposed toward the center of the rotation axis, the high inductance coil necessary in the present invention can be easily set.

Furthermore, in the present invention, particularly when the yoke forming the coil is formed of a silicon steel plate and has low resistance. Since the width of an axis portion is 3 mm or less and turns at least twenty turns or more, and the interlinkage magnetic flux becomes twenty times. With coil polarity at power generation, the phase of the interlinkage magnetic flux and induction current of a generator is delayed by 180 degrees, and magnetic resistance can be zero or reduced. In addition, it is possible to obtain an electromotive force proportional to a temporal change rate of “interlinkage magnetic flux Φ×number of turns of a coil N”.

According to the present invention, it is possible to provide a generator with reduced magnetic resistance and excellent power generation efficiency.

### BRIEF DESCRIPTION OF DRAWINGS

FIG. 1 is a schematic cross-sectional view of a preferred embodiment of the present invention.

FIG. 2 is a relation diagram of interlinkage magnetic flux, induced electromotive force, and induced current in an embodiment indicated in FIG. 1.

FIG. 3 is a schematic view of a high inductance coil and a conventional inductance coil in the embodiment indicated in FIG. 1.

FIG. 4 is a relationship diagram of interlinkage magnetic flux, induced electromotive force, and induced current in the case of using the conventional inductance coil in the embodiment indicated in FIG. 1.

### DETAILED DESCRIPTION

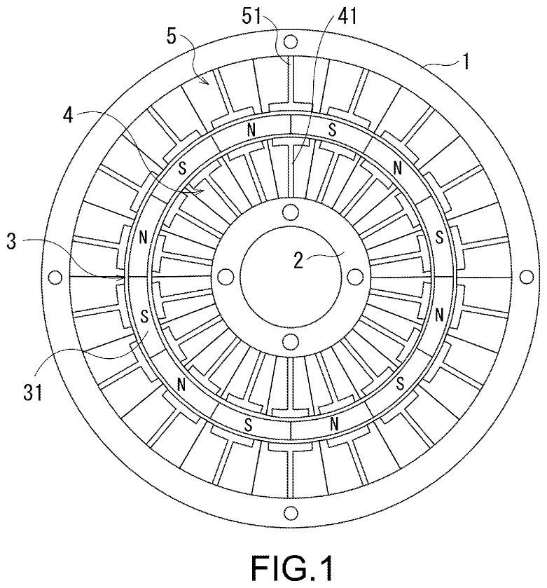

FIG. 1 is a schematic sectional view of a preferred embodiment of the present invention, and a cylindrical rotor 3, a cylindrical inner stator 4, and a cylindrical outer stator 5 are included. The cylindrical rotor 3 is attached to a rotation axis 2 rotatably supported by a housing 1. The cylindrical inner stator 4 is disposed concentrically with the rotor inside the rotor 3 fixed to the housing 1. The cylindrical outer stator 5 is disposed concentrically with the rotor 3 outside the rotor 3.

Then, in the rotor 3, a plurality of permanent magnets 31 is cylindrically disposed in the rotating direction in a state in which the magnetic poles S and N are alternately different. In addition, a plurality of coils 41 and 51 which generates AC voltage when each of the inner stator 4 and the outer stator 5 rotates the rotor 3 is disposed in parallel at a position facing the permanent magnet 31 disposed on the rotor 3 on the side facing the rotor 3.

In the present embodiment, twelve permanent magnets 31 forming the rotor 3 are disposed at an angle of 30 degrees with respect to the axis center. In the case where it is necessary to obtain high induced electromotive force for each permanent magnet 31, materials having high magnetism is preferably selected and used.

In addition, each of the inner stator 4 and the outer stator 5 has eighteen coils 41 and 51. The coils are coaxially disposed radially adjacent to each other with 20 degrees with respect to the axis center.

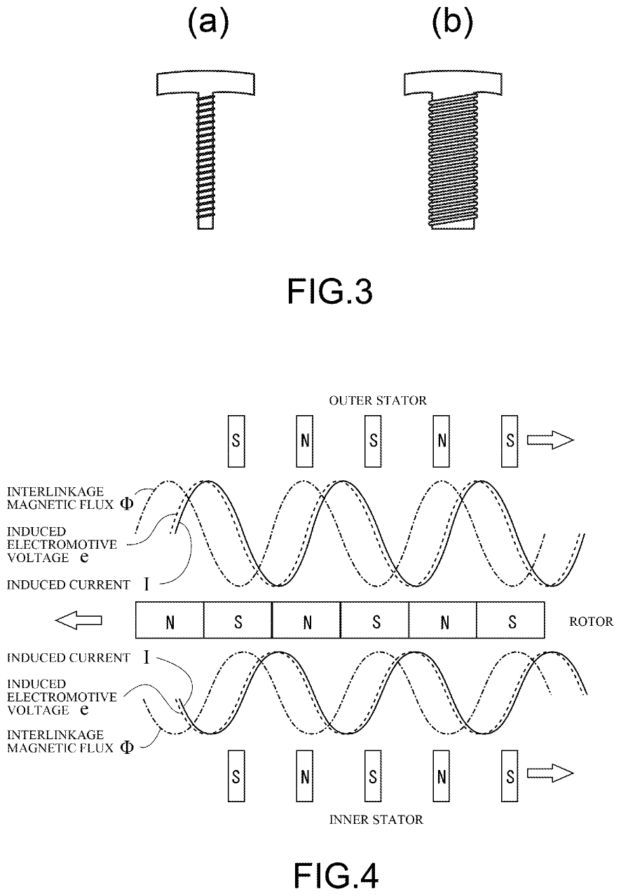

In addition, in the present embodiment, the coils 41 and 51 included in the inner stator 4 and the outer stator 5 are high inductance coils. For example, as indicated in FIG. 3(a), the width of an axis portion in which a top surface is formed of, for example, a silicon steel plate curved along an inner peripheral surface or an outer peripheral surface of the magnet 31 forming the rotor 3 has a T-shaped yoke having a thickness of 3 mm or less, and the yoke preferably has at least twenty turns or more.

FIG. 4 indicates a relation among interlinkage magnetic flux, induced electromotive force, and induced current in a generator (not illustrated) when the axis portion illustrated in FIG. 3(b) is formed as in the embodiment of the present invention illustrated in FIG. 1 by using a normal coil which is not thin, unlike the present embodiment. The induced current I generates a slightly delayed phase with respect to the induced electromotive voltage e. The induced electromotive force is generated in proportion to a change in the magnetic field in the coil, and in accordance with Lenz's law, the induced current flows in a direction hindering the change of the magnetic field. In addition, the inductor has the ability to delay and reform an alternating current. When the interlinkage magnetic flux changes with time, an electromotive force is generated in a coil (electromagnetic induction phenomenon). The induced electromotive force flowing in a circuit by the induced electromotive force generated at this time is proportional to the temporal change of interlinkage magnetic flux number (number of turns xinterlinkage magnetic flux) (Faraday's law). Since the induced electromotive force is generated in a direction hindering the change of the interlinkage magnetic flux, magnetic flux resistance occurs.

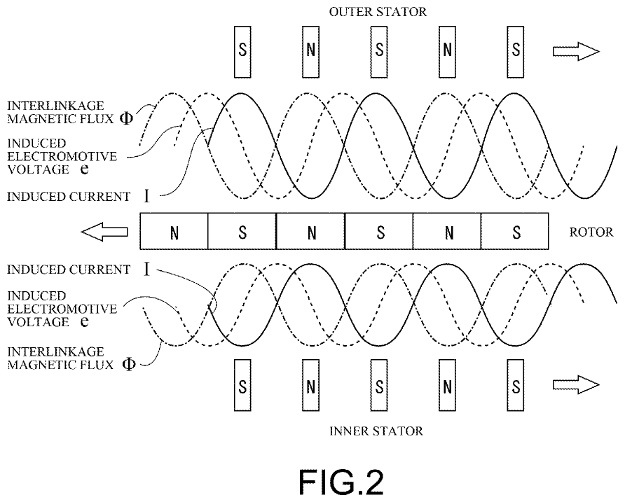

On the other hand, in the present embodiment, as illustrated in FIG. 2, by using a high inductance coil as the coils 41 and 51 disposed on the inner stator 4 and the outer stator 5, with coil polarity at power generation, the phase of the interlinkage magnetic flux and the induced current of a generator is delayed by 180 degrees. Consequently, the magnetic resistance can be zero or reduced.

Further, the coils 41 and 51 disposed on the inner stator 4 and the outer stator 5 in the present embodiment are not formed only with coils without axis cores (yokes). A T-shaped yoke is used which has a thickness of 3 mm or less for an axis portion formed of a silicon steel plate having low resistance, a high inductance coil formed by having at least twenty turns or more is used, and accordingly the phase of the interlinkage magnetic flux and the induced current of a generator is delayed by 180 degrees with the coil polarity at power generation. As a result, the magnetic resistance can be zero or reduced, and although a generation capacity is reduced compared with the case of using a normal coil, it can be secured. In particular, since the inner stator 4 and the outer stator 5 using high inductance coils are disposed on the inside and the outside respectively so as to sandwich the rotor 3, a large amount of power generation can be secured even with a small occupied volume.

Further, in the present embodiment, as described above, the case has been described where the coils 41 and 51 disposed on the inner stator 4 and the outer stator 5 are high inductance coils. For example, by changing the inductance of the coil of the inner stator and the inductance of the outer stator and providing a difference in the high inductance of the coil for reducing the magnetic flux resistance, alternatively, one of the inner stator 4 and the outer stator 5 may be a high inductance coil.

In the present embodiment, the coils 41 and 51 disposed on the inner stator 4 and the outer stator 5 are high inductance coils by having a T-shaped yoke which has a thickness of 3 mm or less for an axis portion formed of a silicon steel plate and having at least twenty turns or more. However, according to the present invention, a cylindrical rotor, a cylindrical inner stator, and a cylindrical outer stator are included. The cylindrical rotor is attached to a rotation axis rotatably supported by a housing. The cylindrical inner stator is disposed concentrically with the rotor inside the rotor fixed to the housing. The cylindrical outer stator is disposed concentrically with the rotor outside the rotor. In the rotor, a plurality of permanent magnets is cylindrically disposed in a state in which magnetic poles are alternately different in the rotating direction of the rotor. In the inner stator and the outer stator, at a position facing the permanent magnet disposed on the rotor on the side facing the rotor, a plurality of coils which generates an AC voltage is disposed in parallel when each of the stators rotates the rotors. In at least one of the coils disposed on the inner stator and the outer stator is, by delaying the phase of the interlinkage magnetic flux and the induced current of a generator by 180 degrees with the coil polarity at power generation, any high inductance coil may be used as long as the magnetic resistance can be zero or reduced. It goes without saying that a high inductance coil having another configuration may be used.

1. A generator with reduced magnetic resistance, comprising:
a cylindrical rotor attached to a rotation axis and rotatably supported by a housing;
a cylindrical inner stator disposed concentrically within the rotor and fixed to the housing;
a cylindrical outer stator concentrically disposed outside the rotor;
a plurality of permanent magnets cylindrically disposed within the rotor such that a N pole and a S pole of adjacent magnets of the plurality of permanent magnets are arranged in an alternating relationship with one another in a rotation direction of the rotor;
a plurality of coils configured to generate an AC voltage when each of the plurality of coils rotates the rotor, the plurality of coils parallely disposed facing the plurality of permanent magnets and arranged on a side of the inner stator facing the rotor and on a side of the outer stator facing the rotor;
wherein at least one of the plurality of coils disposed on the inner stator and the outer stator is a high inductance coil; and
wherein, when a coil polarity is at power generation, magnetic resistance is reducable via delaying a phase of interlinkage magnetic flux and an induced current by 180 degrees.

2. The generator with reduced magnetic resistance according to claim 1, wherein the inner stator and the outer stator are respectively structured as a substantially T-shaped yoke composed of a magnetic material and arranged such that a top surface of the yoke curves along one of an inner surface of the rotor and an outer surface of the rotor; and
wherein an axis of the yoke is disposed toward a center of the rotation axis.

3. The generator with reduced magnetic resistance according to claim 2, wherein the yoke is a silicon steel plate, a width of an axis portion of the yoke is 3 mm or less, and a number of turns of the yoke is at least twenty turns.
